(19) United States
(12) Patent Application Publication
(10) Pub. No.: US 2006/0258780 A1
(43) Pub. Date: Nov. 16, 2006

(54) Method for preparing a silica suspension in a potentially crosslinkable silicone material

(75) Inventors: Marc Chaussade, Villeurbanne (FR); Martial Deruelle, Millery (FR); Gerard Mignani, Lyon (FR); Lucile Gambut-Garel, Lyon (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Boulogne Billancourt (FR)

(21) Appl. No.: 10/541,161

(22) PCT Filed: Dec. 19, 2003
(86) PCT No.: PCT/FR03/03815

§ 371 Date: May 3, 2006

(30) Foreign Application Priority Data
Dec. 30, 2002 (FR) 02 16854

(51) Int. Cl. C08K 9/00; B60C 1/00

(52) U.S. Cl. 523/216; 524/493; 524/588

(57) ABSTRACT

The invention concerns a method for preparing a precipitated silica in a silicone oil, said suspension being useable for producing silicones crosslinkable by polyaddition, polycondensation or condensation by dehydrogenation (elastomers). The invention aims at solving the problem of finding a compromise between cost, rheology and mechanical properties of the final elastomers. Therefor, the invention provides a method for preparing a precipitated silica suspension treated with trimethylchlorosilane, in the presence of hexamethyldisiloxane, in a crosslinkable silicone oil. HCl can be used. Grafting of hydrophobic units on the silica and incorporation of the polyorganosiloxane silicone material are carried out during one single processing sequence, without passing through the powder form for the silica. Sodium silicate promoting MQ resin can be incorporated in the reaction medium. One of the characteristics of the inventive method is that it does not at all comprise a step involving dried hydrophobic silica. The invention also concerns the preparation of crosslinkable silicone elastomer composition from said suspension, and the resulting composition.

The field of the invention is that of charged silicones, and in particular silicone elastomers which can be crosslinked by polyaddition or polycondensation and of antifoam silicone compositions.

More precisely, the present invention relates to the preparation of an intermediate product which is useful for producing these elastomers and these antifoam silicone compositions. This intermediate product consists of a suspension of fine filler (as defined below):
in a polyorganosiloxane (POS) not carrying reactive functional groups,
or in a polyorganosiloxane carrying Si— alkenyl—preferably Si-Vi—functional groups capable of reacting by polyaddition with the Si—H crosslinking functional groups of another POS,
or in a polyorganosiloxane carrying Si—OR⁰ (preferably Si—OH) functional groups capable of reacting by hydrolysis/polycondensation.

In the case of silicone elastomers, the fillers considered are reinforcing fillers, which are to be distinguished from nonreinforcing fillers.

The reinforcing fillers most commonly used are preferably pyrogenic silicas having a BET surface area >50 m²/g. They owe their reinforcing effect, on the one hand, to their morphology and, on the other hand, to the hydrogen bonds which form between the silanol groups on the surface of the silicas and the polyorganosiloxane chains. These interactions between the filler and the polymer increase the viscosity and modify the behaviour of the polymer in the vicinity of the solid surface of the fillers. Moreover, the bonds between polymers and fillers improve the mechanical properties but may also cause damaging premature hardening (“structuring”) of the elastomer precursor compositions.

The nonreinforcing fillers have an extremely weak interaction with the silicone polymer. They are for example chalk, quartz powder, diatomaceous earth, mica, kaolin, aluminas and iron oxides. Their effect is often to increase the viscosity of the uncured precursors of the elastomers, and the Shore hardness and the modulus of elasticity thereof.

The silicone elastomers may also contain, inter alia, catalysts, inhibitors, crosslinking agents, pigments, antiblocking agents, plasticizers and adhesion promoters.

These elastomers, crosslinkable by polyaddition or polycondensation, are formed before crosslinking by casting, extrusion, calendering, coating, with a brush or with a gun, or by compression moulding, by injection or by transfer.

The silicone compositions, cold crosslinkable into elastomers by polyaddition at room temperature or at higher temperatures (generally <200° C.), are conventionally packaged in the form of two-component systems, that is to say comprising two parts which are packaged separately and have to be mixed at the time of use.

In these two-component systems, one of the components comprises the polyaddition reaction catalyst. This catalyst is preferably of the platinum type. It may be for example a platinum complex such as that prepared from chloroplatinic acid and 1,3-divinyl-1,1,3,3-tetramethyldisiloxane, according to patent U.S. Pat. No. 3,814,730 (Karstedt catalyst). Other platinum complexes are described in U.S. Pat. Nos. 3,159,601, 3,159,662 and 3,220,972.

This component containing the catalyst generally additionally comprises a type A POS with crosslinking functional groups Fa: Si-alkenyl, preferably Si-vinyl.

The other component, without catalyst, comprises at least one type B POS with crosslinking functional groups Fb: Si—H.

Generally, the type A POSs and the type B POSs comprise at least two groups Si-Vi and Si—H, respectively, per molecule, preferably at the α,ω position for the type A POSs; at least one of the two having to comprise at least three crosslinking functional groups per molecule.

These two-component systems may also contain a platinum inhibitor which allows the components to only crosslink once mixed together, optionally having been heated. As examples of inhibitors, there may be mentioned:
polyorganosiloxanes, advantageously cyclic polyorganosiloxanes, substituted with at least one alkenyl, tetramethylvinyltetrasiloxane being particularly preferred,
pyridine,
phosphines and organic phosphites (Irgafos® P-EPQ, for example),
unsaturated amides,
alkylated-maleates, and acetylenic alcohols (cf. FR-B-1 528 464 and FR-A-2 372 874).

Such compositions may also be provided in the form of one-component systems which crosslink only after having been heated.

The silicone compositions, which can be crosslinked or hardened into elastomers by polycondensation at room temperature or at higher temperatures (generally <100° C.), are conventionally-packaged in the form of one-component systems (that is to say comprising a single packaging), or two-component systems (that is to say comprising two parts packaged separately and which have to be mixed at the time of use).

In the two-component systems, one of the components comprises in particular a type C POS having reactive ends Fc, in particular hydroxydimethylsiloxy, the other component containing the polycondensation reaction catalyst. This catalyst may be a metal compound, for example an organic compound of tin. This compound containing the catalyst may also comprise a crosslinking agent D carrying functional groups Fd capable of reacting with the reactive functional groups Fc of the C POS.

Such compositions may also be present in the form of one-component systems which crosslink at room temperature, in the presence of moisture.

In the case of antifoam compositions based on nonreactive silicones, the fillers used are particular fillers such as those mentioned above for the elastomer compositions. These fillers act through their non-deformable character, their geometry and their dimensions and through the interactions which they exchange with the surrounding medium.

The preparation of concentrated suspensions (slurries) of particulate reinforcing fillers in reactive or nonreactive silicone oils intended to produce crosslinkable elastomers or antifoam silicone compositions, is a stage of the methods of producing elastomer compositions which is very widespread in the field of silicone elastomers.

The particulate reinforcing fillers most widely known are based on pyrogenic silica, but substances such as precipitated silica, titanium oxide, for example, may also be used in some cases

These fillers have a BET specific surface area of at least 1 m²/g up to generally 400 m²/g. They are ultrafine powders which may be dispersed in silicone oils. This dispersion poses problems of mixing the pulverulent filler with oil and care should be particularly taken to obtain a uniform distribution of the filler in the suspension.

Another difficulty to be overcome is linked to the rheology of the suspensions prepared. Indeed, it is clear that the introduction into silicone oil of a pulverulent particulate filler of very small particle size necessarily introduces a notable increase in the viscosity. However, this characteristic, although it is associated with the obtaining of good mechanical properties for the silicone elastomers comprising the suspension as raw material, is damaging to the handling and to the forming of the suspension and of the silicone compositions containing it. It is indeed more convenient, for moulding, extrusion, coating or forming, to handle fluid compositions which readily lend themselves, inter alia, to pumping, flowing or mixing with functional additives.

As regards the antifoams, fluid compositions are generally sought; the use of a manufacturing intermediate consisting of a concentrated suspension in accordance with the invention, described below, is a means for achieving this objective.

These problems linked to the handling of the reinforcing fillers and to the very high viscosity of the slurries containing them cause a third major disadvantage of an economic nature linked to the complexity of the materials to be used.

The problem considered here can therefore be summarized as being the search for a new method for preparing suspensions of fine particulate fillers in silicone oils:
which leads to homogeneous suspensions having a fine distribution of particles in the silicone matrix,
which offers matching of the rheology of the suspension to the handling constraints (“processability”),
which makes it possible to obtain in fine crosslinked elastomers having satisfactory mechanical properties,
and which is economical.

A number of methods for preparing suspensions of fine particulate fillers in silicone oils coupled with a compatibilization treatment of the fine particulate filler (silica) are known. This treatment is intended to make the reinforcing preferably silicic-filler compatible with the silicone phase. Indeed, this type of rather hydrophilic filler gains in becoming hydrophobic in order to be able to better exert its function of mechanical reinforcement of the silicone material, once crosslinked.

There are two main types of compatibilizing agents:
those based on HexaMethylDisilaZane (HMDZ),
and those based on halosilanes (chlorosilanes).

This compatibilization treatment can take place before and/or during and/or after the incorporation of the filler (e.g. silica) into the polyorganosiloxane oils.

Numerous patent documents relate to the preparation of HMDZ-treated silica suspensions in a polyorganosiloxane silicone material.

It is thus the case for the following references:
French patent application FR-A-2 320.324 describes a method for the homogeneous distribution, in polyorganosiloxane oils, of a filler based on highly dispersed pyrogenic silica having a BET specific surface area of at least 50 m²/g. This method is characterized in that the filler is treated during the incorporation, in the presence of water, with a compatibilizing agent (hexamethyldisilazane). This compatibilization treatment of silica with silicone oil may be termed “early” since the HMDZ is present from the bringing of the reinforcing fumed silica into contact with this silicone oil.
European patent application EP-A-0 462 032 describes a method for preparing a slurry which can be used in particular in compositions which can be crosslinked by polyaddition reaction. In this method, the compatibilization treatment using hexamethyldisilazane occurs after the incorporation of silica into the silicone oil. This mode of treatment is termed here “late”.
American U.S. Pat. No. 4,785,047 discloses a mixed compatibilization treatment at the frontier between the early and the late treatments mentioned above. This patent relates more specifically to a method for preparing transparent silicone elastomers.
Patent applications PCT WO-A-98/58997 and WO-A-00/37549 relate to methods for preparing slurries containing reactive silicone oils by polyaddition and polycondensation, respectively, in which a first HMDZ fraction (less than 8% in total) is introduced before bringing into contact with the silicone oil/powdered fumed silica and the remainder of the HMDZ afterwards.
Patent application PCT WO-A-02/44259 discloses the preparation of a precipitated silica suspension in a silicone oil, it being possible for this suspension to be used for producing silicones crosslinkable by polyaddition or by polycondensation (RTV elastomers). The precipitated silica is treated with hexamethyldisilazane (HMDZ) introduced in two fractions (15 and 85%) into a crosslinkable silicone oil. The first fraction is first of all brought into contact with precipitated silica and water.

As regards preparations of silicone compositions comprising a silicic filler made hydrophobic with chlorosilanes, the following patent documents may be mentioned:
U.S. Pat. No. 3,122,520 discloses the hydrophobization of silica, which consists in bringing an aqueous silica slurry into contact with HCl and in heating this mixture to between 50 and 250° C. (pH close, to 0). Isopropyl alcohol and hexamethyldisiloxane are then added isopropyl alcohol or any other organic solvent immiscible with water allows the transfer of the “hydrophobized” silica into an organic phase. The aqueous phase is separated from the organic phase and the removal of this aqueous phase is completed by a devolatilization step.
The document WO-A-01/14480 teaches the presence of a coupling agent (a) (e.g. MeViSiCl₂) and of an organometallic hydrophobizing compound (b) (e.g. Me₂SiCl₂). Isopropyl alcohol, HexaMethylDiSiloxane (HMDS or M₂) or toluenze also form part of the reagents in addition to the aqueous silica slurry. The temperature is also increased (65° C.).
The content of the document WO-A-01/12730 is comparable to that of the document WO-A-01/14480. The hydrophobization of silica in the form of an aqueous slurry is carried out at acidic pH (H₂SO₄ or HCl), in the presence of isopropanol, of HMDS with heating to 60-70° C. The abovementioned hydrophobized silica particles are then transferred into an organic phase based on hexane for example. The aim is to have 2 to 15 OH/nm², a methanol wettability of 15 to 45% and, after neutralization, a reduced carbon content (close to 0) and a pH between 3 and 10 and a whiteness M₁ of less than 0.4%.
The document EP-A-1 048 696 (=U.S. Pat. No. 6,184,408) relates to a process for preparing precipitated silica, in which this precipitated silica is mixed with isopropyl alcohol, with water, with HMDS, and then with concentrated HCl and finally again with isopropyl alcohol. After mixing for three hours at room temperature, toluene is used in which the transfer of the hydrophobized precipitated silica occurs.

HMDS may be replaced by Me₂SiCl₂.
The document U.S. Pat. No. 5,919,298 discloses the treatment of fumed silica with HMDS, HCl, water and isopropanol. The hydrophobization is carried out at room temperature. This patent also discloses the replacement of HMDS by a hexenyldimethylchlorosilane and dimethyldichlorosilane combination, with subsequent use of hexane to carry out the transfer of hydrophobized silica into an organic phase.
In the document WO-A-99/36356, the silica used is in the form of an aqueous slurry and the reaction medium comprises Me₂SiCl₂ in addition to isopropanol and HCl. The transfer takes place in heptane. The hydrophobization is carried out at room temperature.

In all these documents illustrating the chlorosilane route for the compatibilization treatment, the “hydrophobized” reinforcing silica is isolated in powdered form, so as to be stored in this state and then incorporated into a silicone material comprising crosslinkable polyorganosiloxane oils. They do not therefore involve continuous processes for preparing silicone compositions charged with hydrophobic silica, comprising both the hydrophobization treatment and the mixing of this silica with polyorganosiloxane silicone materials.

These known methods are not therefore the most economical because of their complexity (numerous handlings) and large quantities of energy which they require for making into hydrophobic silica powders and for mixing these powders with polysiloxane oils, which may be relatively viscous.

American U.S. Pat. No. 5,942,590 describes the preparation of a silica gel in which a colloidal silica is incorporated, this silica gel being made hydrophobic by treatment with dimethyldichlorosilane at pH 5.5. According to this preparation, a silica hydrogel is prepared from sodium silicate and water acidified with HCl. Colloidal silica is added to this hydrogel and the pH of the solution thus obtained is adjusted to 2.5. The passage of the pH from 2.5 to 5.5 and the addition of a sodium silicate solution causes the conversion of the silica suspension into a silica gel. After removing part of the water by heating under, reflux, with stirring, for two hours, the silica gel is supplemented with isopropanol and dimethyldichlorosilane. This addition is followed by a heating step in which the silica is functionalized with dimethyldichlorosilane. After removing water, HCl and isopropanol by decantation, a hydrophobic silica is recovered in toluene. The latter is then removed by thermal devolatilization in order to obtain a dry hydrophobic gel. Dimethyldichlorosilane may be replaced by hexamethyldisiloxane (M₂).

These hydrophobic dry silica gels may be used as a reinforcing filler in silicone elastomer compositions.

The necessary passage via a dry hydrophobic silica gel is a notable disadvantage of the technical content of the document. Indeed, this suggests an expensive heat treatment, which makes the process more complex. In addition, it should be emphasized that the planned adjustments of pH in the method according to U.S. Pat. No. 5,942,950 are not easy to use in an industrial process. Furthermore, they are capable of generating awkward salts in particular because they induce instability, they carry residual hydrophilicity and they can interfere with the transparency of the material.

In such a technical context, one of the main objectives of the present invention is to provide an economical method for preparing a suspension of a particulate filler treated with a compatibilizing agent based on halosilanes, in a silicone oil, it being possible for this suspension to be useful as raw material for producing:
two-component, or even one-component, silicone compositions which can be crosslinked in particular by polyaddition, polycondensation or dehydrogenocondensation to silicone elastomers,
or antifoam silicone compositions.

This method has to satisfy the following specifications:
coupling in one and the same manufacturing sequence the compatibilization treatment of silica in particular using halosilanes and mixing the silica with a polysiloxane silicone material which can be used directly as raw material for the preparation of crosslinkable silicone compositions,
uniformization and homogenization of the distribution of the filler in the silicone oil,
optimization of the dispersion,
viscosity matched to handling and conversion of the suspension,
mechanical properties of the elastomers resulting from an acceptable level, or quality antifoam properties,
reduced cost.

Another main objective of the invention is to provide a method for preparing a reinforcing filler/silicone oil suspension for elastomers, which is simple to use and applicable on an industrial scale.

Another main objective of the invention is to provide an efficient and direct method for producing a reinforcing filler suspension in a silicone oil for elastomers, this method being of the type referred to in the abovementioned objectives.

Another main objective of the invention is to provide a method for producing a silicone composition which can be crosslinked by polyaddition or, polycondensation, for forming an elastomer and comprising, as constituent element, the suspension as obtained by the method referred to above.

Another main objective of the invention is to provide a method for producing an antifoam silicone composition and comprising, as constituent element, the suspension as obtained by the method referred to above.

These objectives, among others, are achieved by the present invention which relates, according to a first embodiment, toga method for preparing a suspension of a silicic particulate filler, in a silicone material (SM) comprising:
SM₁polyaddition:
   at least one type A polyorganosiloxane POS carrying alkenyl crosslinking functional groups Fa capable of reacting with the crosslinking functional groups Fb (SiH) of at least one B type POS, this A POS being taken alone or as a mixture with at least one nonreactive (E) POS;
   and at least one B type POS carrying crosslinking functional groups Fb (SiH) capable of reacting with the alkenyl crosslinking functional groups Fa of the A POS(s);
and/or SM₂polycondensation:
   at least one C type POS carrying hydroxyl crosslinking functional groups Fc and/or OR functional groups (R═C₁-C₂₀ alkyl) precursor of the functional groups Fc′, these crosslinking functional groups Fc being capable of reacting with crosslinking functional groups Fc of this C POS or of other C POSs, and with crosslinking functional groups of at least one crosslinking agent D, this C POS being taken alone or as a mixture with at least one nonreactive (E) POS;
and/or S₃polydehydrogenocondensation:
   at least one C′ type POS carrying hydroxyl crosslinking functional groups Fc′ and/or OR′ functional groups (R′=C₁-C₂₀ alkyl) precursor of the functional groups, Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
   and at least one B′ type POS carrying crosslinking functional groups Fb′ (SiH) capable of reacting with the crosslinking functional groups Fb′ OH or OR′ of the C′ POS(s);
and/or SM₄:
   or at least one nonreactive, (E) POS;

this suspension being capable of being used in particular for producing compositions which can be crosslinked by polyaddition and/or by polycondensation and/or by dehydrogenocondensation or antifoam silicone compositions;

this method being of the type in which an aqueous suspension of silicic particulate filler is made hydrophobic by treating with at least one halogenated reagent, this treatment comprising a transfer of the silica made hydrophobic into a nonaqueous phase and at least one step for at least partial removal of water; characterized in that:
a) an aqueous silica suspension is prepared, or used which comprises:
   silica,
   water which is optionally acidified,
   at least one hydrogen bond stabilizer/initiator;
b) optionally, part of the silicone material SM is incorporated into the aqueous silica suspension obtained at the end of step a);
c) hydrophobic units formed by ≡Si—(R^{c})_{1 to 3} with R^{c}=hydrogeno, C₁-C₃₀ alkyl, C₂-C₃₀ alkenyl, aryl, these groups R^{c} being optionally substituted (preferably halogenated), are grafted onto the silica by exposing this silica to halosilanes that are precursors of these units and by allowing the reaction to proceed, preferably while stirring the whole, optionally in the hot state;
d) the procedure is carried out such that the transfer of the silica grafted by hydrophobic units, from the aqueous phase to the nonaqueous phase, is carried out;
e) optionally, at least part of the aqueous phase and of the reaction by-products is drawn off;
f) the medium is cooled if necessary;
g) optionally, the residual acidity of the nonaqueous phase is washed off;
h) the totality or the remainder of the silicone material SM is mixed with the filler which is now hydrophobic;
i) the residual water is evaporated off;
j) and an oil is recovered which consists of a hydrophobic particulate filler suspension in a crosslinkable silicone material, preferably without ever passing via a dried hydrophobic silica.

The expression “dried hydrophobic silica” is understood to mean, for the purposes of the present invention and in the whole of the present disclosure, a hydrophobic silica containing less than 10% of extractables not attached to the hydrophobic silica. The term “extractables” denoting:
either volatile products which can be removed from the hydrophobic silica by treating for one hour at 150° C., at normal atmospheric pressure;
or products extractable from hydrophobic silica through contact with a solvent for silicones (e.g. hexane, cyclohexane, heptane, CCl₄, octane, dichloromethane, toluene, methyl ethyl ketone, methyl isobutyl ketone, white spirit, xylene), at the rate of 5 and 30% by weight of hydrophobic silica relative to the solvent, for at least 8 days, with stirring, at 25° C. and at normal atmospheric pressure.

It is to the credit of the inventors, after numerous research studies and experiments:
to have attempted the coupling of the treatment in order to make hydrophobic the silica and the mixture of the latter with silicone oil, in one and the same operating protocol, without passing via the pulverulent state for the silica; knowing that it might have been feared a priori that water or acidity would remain and that the transfer would not occur;
and used halosilanes (e.g. chloro) in an, aqueous medium, without compromising, as a result, the stability of the halosilane reagents and thus allow them to react with the silica.
   The advantages of this novel method for producing silicic suspensions are in particular:
significant reduction in cost,
ease of use,
production of suspensions having appropriate rheological qualities and viscoelastic behaviour (no or low yield point); in particular they have a fluidity which is stable over time and suitable for the handling and processing operations, such as pumping, conveying, mixing, forming, moulding, extrusion, and the like,
and moreover ease of use degassing for the elastomer compositions prepared from these suspensions.

For the purposes of the invention, the possibility attached at step e) of drawing off the aqueous phase is interpreted as follows:
for an elastomeric silicone composition, step e) is obligatory and it is even completed by a devolatilization (distillation) in order to completely eliminate the volatiles including water;
for an antifoam silicone composition, it is possible optionally to dispense with the removal of the volatile species including, water, for subsequent emulsification.

One of the major advantages of the invention is that this economic benefit is not achieved at the expense of the other advantages of the method and of the final mechanical properties of the crosslinked elastomer or of the antifoam properties, depending on the case.

According to a preferred modality of the invention, the pH of this suspension is ≦2, preferably ≦1, at least during step a) (advantageously throughout the process).

The invention also relates to a treatment intended to make the silica hydrophobic, this treatment being capable of being carried out in the method for preparing a suspension of a filler (for example a silicic filler) in a silicone.

This method is characterized in that:
a′) the following are brought into contact:
   an aqueous silica suspension comprising 100 parts by dry weight of silica, optionally acidified with 20 to 60 (preferably 30 to 50) parts by weight of at least one acid, knowing that the pH of the nonaqueous phase is preferably ≦to 2, and preferably ≦to 1;
   0 to 500 (preferably 0 to 300) parts by weight of a precursor of silicone resin, preferably sodium silicate,
   5 to 500 (preferably from 10 to 200) parts by weight of a stabilizer/nonaqueous hydrogen bond initiator,
   5 to 500 (preferably from 10 to 200) parts by dry weight of at least one precursor of hydrophobic units formed by units ≡Si—(R^{c})_{1 to 3} with R^{c}=hydrogen, C₁-C₃₀ alkyl, C₂-C₃₀ alkenyl, aryl, these groups R^{c} being optionally substituted (preferably halogenated),
   40 to 2 000 (preferably from 50 to 800) parts by weight of silicone material SM
b′) the reaction medium thus obtained is heated,
c′) the medium is optionally cooled,
d′) the aqueous phase and reaction by-products are drawn off,
e′) the nonaqueous phase comprising the now hydrophobic silica is recovered,
f′) optionally the residual acidity of the nonaqueous phase is washed off,
g′) optionally the liquid is removed from the nonaqueous phase so as to recover the hydrophobic silica in pulverulent form.

Advantageously, the water represents 2 to 8 000, preferably 200 to 1 000, parts by weight per 100 parts by weight of silica on dry matter.

This original succession of operations makes it possible to optimize the grafting of hydrophobic units —Si—(R^{c})₁ to 3 onto silica.

The expression “silicone resin” is understood to mean, for the purposes of the invention, a resin comprising siloxy units Q and/or T and optionally siloxy units M and/or D and/or Q^{ORq′} and/or T^{ORt′} and/or M^{ORm′} and/or D^{ORd′}.

The following rules of nomenclature are adopted in the present disclosure for the siloxy units:

M: (R^{m})₃SiO₁/2

with R^{m}=hydrogen, C₁-C₃₀ alkyl, C₂-C₃₀ alkenyl, aryl, these groups R^{m} being optionally substituted (preferably halogenated)

M^{ORm′}: (R^{m})ₐ(ORm′)_{b}SiO_{1/2}

with R^{m} as defined above and a+b=3 and Rm′=H or a radical having the same definition as R^{m}

D: (R^{d})₂SiO_{2/2}

with R^{d} having the same definition as that given above for R^{m}

D^{ORd′}: (R^{d})(ORd′)SiO_{2/2}

with R^{d} as defined above and Rd′=H or a radical having the same definition as R^{m}

T: (R^{t})SiO_{3/2}

with R^{t} having the same definition as given above for R^{m}

T^{ORt′}: (ORt′)SiO_{3/2}
with Rt′=H or a radical having the same definition as R^{m} 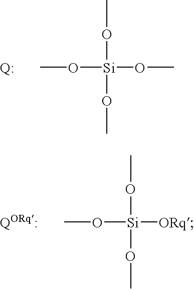
with Rq′=H or a radical having the same definition as R^{m}.

The introduction of a silicone resin precursor into the reaction medium during step a) of the method for preparing a silica suspension in an oil, according to a preferred embodiment of the invention or during step a′) of the abovementioned “hydrophobicization” treatment of silica, corresponds to an advantageous variant of the invention.

The precursor of such silicone resins (preferably a sodium silicate) converts to a polysilicic acid in the presence of acidified water preferably at a pH of ≦2. This acid forms a network of units Q which form aggregates on the silica initially used. The functionalization (“hydrophobization”) of the network using CA II then occurs.

A silicone phase is thus obtained which contains MQ resin with a core Q which is large in size. The aqueous phase is free of any trace of silica.

The precursor of such resins is preferably a sodium silicate (SiO₂, Na₂O) with an SiO₂/Na₂O weight ratio advantageously between 3.2 and 3.6.

It is used in an amount of 20 to 40% by weight, preferably approximately 35% by weight relative to the water present in the medium.

In practice, the precursor of silicone resins may be used in the form of an aqueous solution.

The conditions for forming silicone resins (for example MQ) are advantageously those conforming to those described in U.S. Pat. No. 2,676,182 and U.S. Pat. No. 2,814,602.

According to an advantageous variant of the process according to the invention, functional units other than the hydrophobic units are grafted on the silica by bringing the latter into contact with halosilanes which are precursors of these functional grafts.

The functions which may be given to the silica by these units are for example the following: bactericidal, bacteriostatic, chromophoric, fluorescence, anti-fouling, refractive index modifier, coupling with the silicone network (e.g. haloalkoxyalkenylsilane, and the like) and combinations thereof.

To complete the method according to the invention, the most appropriate conditions proved to be those consisting in choosing:
one or more precipitated silicas, preferably existing mainly in slurry form and whose BET specific surface area is between 50 and 400 m²/g,
and mixing conditions such that the dynamic viscosity at 25° C. of the suspension is less than or equal to 300 Pa·s, preferably less than or equal to 150 Pa·s.

Further details on the preferred precipitated silicas in accordance with the invention are given below.

Conventionally, a precipitated silica results from a succession of operations which may be for example:
precipitation of silica in aqueous phase by acidification, by addition of acid to a stock solution of silicate or by total or partial simultaneous addition of acid and of silicate to a stock solution of water or of silicate solution,
filtration which makes it possible to recover a phase enriched with silica,
optionally disintegration of the precipitated silica filtrate in order to prepare an aqueous suspension which is easy to handle,
optionally drying of the precipitated silica,
optionally grinding and/or compacting of the precipitated silica powder,
and optionally packaging in bags the powdered, precipitated silica thus obtained.

The precipitated silica preparation used in the context of the invention is described in the documents EP-A-0 520 862, WO-A-95/09127 and WO-A-95/09128.

Thus, the precipitated silica used in the method according to the invention may be provided in powder form or in the form of an aqueous slurry collected at the filtration or disintegration stage.

For the purposes of the invention, the term “powder” used to describe the precipitated silica denotes precipitated silica in the solid state, generally provided in pulverulent form or in the form of substantially spherical granules or beads.

According to a preferred characteristic of the invention, one or more precipitated silicas are chosen whose BET specific surface area is between 50 and 400 m²/g and mixing conditions such that the dynamic viscosity at 25° C. of the suspension (slurry) is less than or equal to 300 Pa·s, preferably less than or equal to 150 Pa·s. The BET specific surface area is determined according to the BRUNAUER, EMMET, TELLER method described in “The Journal of the American Chemical Society, vol. 80, page 309 (1938)” corresponding to the NFT 45007 standard of November 1987.

Advantageously, the (precipitated) silica filler preferably represents from 10, to 50% by weight of the suspension. In practice, this filler is of the order of 30±10% by weight.

According to an advantageous characteristic of the invention, the hydrogen bond stabilizer/initiator is chosen from organic solvents, preferably from the group comprising alcohols (in particular isopropyl alcohol, ethanol and butanol), ketones (in particular Methyl IsoButyl Ketone: MIBK), amides (in particular DiMethylACetamide: DMAC), alkanes (in particular tetrahydrofuran: THF) and mixtures thereof.

It may be noted that the acidification of the aqueous suspension (aqueous phase) which may occur in the method according to the invention is otherwise, carried out using an acid, preferably an inorganic acid, and still more preferably an acid is chosen from the group comprising: HCl, H₂SO₄, H₃PO₄ and mixtures thereof.

A means other than the external supply of acid in order to maintain the pH of the aqueous suspension (aqueous phase) below the required limit consists in the in situ formation of acid—preferably HCl—by reacting the halosilane precursor of hydrophobic units, with water.

Preferably, the silicone material SM comprises at least one oligoorganosiloxane, preferably a diorganosiloxane, and still more preferably hexamethyldisiloxane (HMDS or M₂).

The oligoorganosiloxane(s) of the SM may be combined with one or more polyorganosiloxanes (POS) of any type, in particular A, B, C, D, E as referred to above and defined in greater detail below.

For the purposes of the invention, the term “oligoorganosiloxane” denotes a siloxane oligomer comprising from 2 to 10 M, D or T type siloxy units as defined above, while a polyorganosiloxane denotes a polymer comprising from 11 to 10 000 thereof, preferably from 100 to 5 000.

In accordance with the invention, the silicone material SM of an oligoorganosiloxane nature preferably corresponds to the first fraction optionally used in step b) of the method according to the invention for preparing a silica suspension in a silicone oil.

Advantageously, the halosilane precursor of hydrophobic units is an alkylhalosilane, preferably an alkylchlorosilane, and still more preferably a methylchlorosilane.

This alkylhalosilane is very advantageously a monosilane type blocker, for example (CH₃)SiCl. This blocker limits the growth of the silica, or even of the silicone resin derived from the silicate, preferably sodium silicate, used in step a) or a′).

In accordance with the invention, it is not out of the question to provide additionally or as a replacement for the preferred blocker(s) referred to above one or more halosilanes which are different and chosen from the group comprising:
dialkyldihalomonosilanes, for example (CH₃)₂SiCl₂,
dialkylhydrogenohalomonosilanes, for example (CH₃)₂SiCl₂,
alkylhydrogenodihalomonosilanes, for example CH₃SiHCl₂,
alkylalkenyldihalomonosilanes, for example (CH₃)ViSiCl₂,
dialkylalkenylhalomonosilanes, for example (CH₃)₂ViSiCl,
alkyltrihalomonosilanes, for example (CH₃)SiCl₃,
hydrogenotrihalomonosilanes, for example HSiCl₃,
alkenyltrihalomonosilanes, for example ViSiCl₃:
and mixtures thereof.

The alkyl may be a C₁-C₃₀ alkyl, alkenyl, a C₂-C₃₀ alkenyl. The alkyl, alkenyl or hydrogeno substituents may be combined or replaced by an aryl. These alkyl, alkenyl or aryl groups may be optionally substituted (preferably halogenated).

The preferred alkyl and halogen are methyl and chlorine respectively and the alkenyl is preferably Vi=vinyl.

In accordance with a preferred embodiment, the method according to the invention essentially consists in using a precipitated silica powder and in using the following operations:
the relevant products are introduced into the stirred preparation vessel in the following order:
   1. the aqueous silica suspension, optionally in several fractions, the hydrogen bond stabilizer/initiator—preferably consisting of isopropyl alcohol—, optionally an acid—preferably HCl—;
   2. a precursor of hydrophobic units: ≡Si—(R^{c})_{1 to 3} with R^{c}=hydrogeno, C₁-C₃₀ alkyl, C₂-C₃₀ alkenyl, aryl, these R^{c} groups being optionally substituted (preferably halogenated), preferably (CH₃)₃SiCl—;
   3. part of the SM consisting of at least one oligoorganosiloxane—preferably, hexamethyldisiloxane (M₂)—;
the medium is heated to a temperature in the region of the reflux temperature of the hydrogen bond stabilizer/initiator—preferably that of isopropyl alcohol between 70 and 80° C.;
the medium is optionally cooled;
the aqueous phase is separated from the nonaqueous phase—preferably by decantation—;
the nonaqueous phase is removed;
optionally at least once, this nonaqueous phase is washed with an aqueous liquid and then the aqueous washing phase is removed;
the optionally washed, nonaqueous silicone phase is mixed with all or the remainder of the silicone material SM, with the silica now hydrophobic, this SM preferably comprising at least one polyorganosiloxane POS;
an oily suspension of hydrophobic particulate silicic filler is recovered in a crosslinkable silicone material SM, without ever passing via a dried hydrophobic silica.

In this preferred embodiment with powdered precipitated silica, the proportions of the various ingredients are the following (parts by dry weight for all that is not water):
silica: 100;
acid (e.g. HCl): 20 to 60, preferably from 30 to 50;
precursor of —Si—(R^{c})_{1 to 3} {e.g. (CH₃)₃SiCl}, 5 to 500, preferably from 10 to 200;
H bond stabilizer/initiator (e.g. isopropanol): 0 to 20, preferably from 1 to 10;
SM oil: 40 to 2 000, consisting exclusively or otherwise of oligoorganosiloxane—preferably of M₂;
water: 2 to 8 000, preferably 200 to 1 000.

The silica used preferably exists essentially in the form of a precipitated silica slurry. This avoids the step for preparing the slurry in the preparation vessel. Moreover, it is clear that the handling of a slurry is much easier than the handling of large volumes of powder, which furthermore require expelling the corresponding air from the mixture during production.

The dryness of the silica slurry is generally between 1 and 50% by weight, preferably between 10 and 40% by weight.

This novel method of preparation is found to be particularly economical and allows easy incorporation of the ingredients with tools which use little energy. Indeed, the composition remains easily malleable during the entire process without requiring an enormous amount of power for the mixing. This method results furthermore, in the case of crosslinkable silicone elastomers, in properties for using the elastomers which are completely consistent with the expected specifications, compared with conventional methods using fumed silica. The same applies in the case of slurries intended for preparing antifoam compositions.

The various stages of the method may be of varying durations and are performed in separate appliances.

Regardless of the powder or slurry form of the precipitated silica, it is particularly advantageous to note that the degassing of the compositions for elastomers, prepared with the slurry, is much easier than previously.

As regards the silicone oils used in the method according to the invention, there may be preferably chosen linear or cyclic, and preferably linear, polydiorganosiloxanes.

Thus, the silicone material may be, in the first place, a polyaddition SM, containing:
at least one reactive silicone oil A POS whose crosslinking functional groups Fa are alkenyl preferably vinyl—functional groups,

these A POSs:
comprising at least two Si-Fa groups per molecule, preferably each situated at one end of the chain,
and having a dynamic viscosity at 25° C. of less than or equal to 250 Pa·s, preferably 100 Pa·s and still more preferably 10 Pa·s,

this A POS being intended to react with the B POS,
at least one reactive silicone oil B POS, whose crosslinking functional groups Fb are hydrogen functional groups, this B POS comprising at least two groups Si—H per molecule (preferably at least three when the A POS comprises only two Si-Vi groups per molecule), these Si—H groups being advantageously situated in the chain,
and/or at least one nonreactive E POS.

For this silicone material SM₁ to be crosslinkable by polyaddition, it is necessary to add to it:
a catalytic system comprising a polyaddition metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

The A POS may be for example an α,ω-divinylated polydialkyl-(methyl)-siloxane oil. Preferably, the A POS used for the preparation of the suspension is a vinylated A POS carrying at least two Si-Vi units per molecule, preferably at least three per molecule, when the B POS contains only two Si—H units per molecule.

The B POS is for example polyalkyl(methyl)hydrogenosiloxane or alternatively a branched hydrogenated POS containing tri- or tetrafunctional units and units carrying SiH.

The E POS may be a polydiorganosiloxane, such as a polyalkylsiloxane, preferably polydimethylsiloxane with trimethylsilyl ends.

The preferred silicone oils (A, B, E) mainly comprise R¹₂SiO units, the symbols R¹, which are identical or different, representing optionally halogenated C₁-C₃₀ (cyclo)alkyl groups, optionally halogenated C₂-C₃₀ (cyclo)alkenyl groups or optionally substituted or halogenated aryl groups.

By way of:
alkyl groups: methyl, ethyl, propyl and butyl groups may be particularly mentioned,
halogenated alkyl groups: 3,3-trifluoropropyl may be mentioned,
cycloalkyl groups: cyclohexyl may be mentioned,
alkenyl groups: vinyl,
aryl groups: phenyl group may be mentioned.

Secondly, the silicone material may be a polycondensation SM₂′ containing:
at least one reactive silicone oil C POS whose crosslinking functional groups Fc react by polycondensation, these C POSs corresponding to the following formula (1): 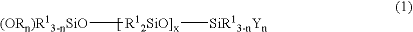
in which:
   R¹ represents monovalent hydrocarbon radicals which are identical or different, and Y represents hydrolysable or condensable groups OR with R¹¹ corresponding to the same definition as that given above for R^{c},
   n is chosen from 1, 2 and 3 with n=1 when R═H is a hydroxyl, and x has a sufficient value to confer on the oils of formula (1) a dynamic viscosity at 25° C. of between 1 000 and 200 000 mPa·s,
this C POS being intended to react with another C POS or with at least one crosslinking agent D,
and/or at least one nonreactive E POS different from the C POS(s).

For this silicone material SM₂ to be crosslinkable by polycondensation, it is necessary to add to it:
a catalytic system comprising a condensation metal catalyst;
optionally one or more semireinforcing, nonreinforcing or bulking fillers;
optionally water;
optionally one or more additives chosen from pigments, plasticizers, other rheology modifiers, stabilizers and/or adhesion promoters.

In the products of general formula (1) which are industrially used, at least 80% in numerical terms of the radicals R are methyl radicals, the other, radicals may generally be phenyl radicals.

The reactive C POSs preferably used are the α,ω-dihydroxylated diorganopolysiloxanes of formula (1) in which Y=OH, n=1 and x has a sufficient value to confer on the polymers a dynamic viscosity at 25° C. of between 1 000 and 200 000 mPa·s and preferably between 5 000 and 80 000 mPa·s.

It should be understood that, in the context of the present invention, it is possible to use as hydroxylated C POSs of formula (1) a mixture consisting of several hydroxylated polymers which differ from each other by the value of the viscosity and/or the nature of the substituents linked to the silicon atoms. It should be indicated furthermore that the hydroxylated polymers of formula (1) may optionally comprise, apart from the D units, T units and/or Q units in the proportion of at most 1% (these percentages expressing the number of T and/or Q units per 100 silicon atoms).

This polycondensation SM₂ may also comprise a nonreactive silicone oil comprising nonreactive E POSs corresponding to the following formula (2): 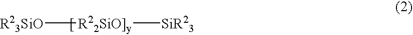
in which:
the substituents R², which are identical or different, represent monovalent hydrocarbon radicals, preferably C₁-C₃₀ alkyl, C₂-C₃₀ alkenyl, aryl, which are optionally substituted (preferably halogenated),
the symbol y has a sufficient value to confer on the polymers a dynamic viscosity at 25° C. of between 10 and 10 000 mPa·s.

As examples of radicals R², there may be mentioned the alkyl radicals having from 1 to 8 carbon atoms, such as methyl, ethyl, propyl, butyl, hexyl and octyl radicals, and phenyl radicals.

As examples of substituted radicals R², there may be mentioned the 3,3,3-trifluoropropyl, chlorophenyl and beta-cyanoethyl radicals.

By way of illustration of units represented by the formula R²₂SiO, there may be mentioned those of formulae:
(CH₃)₂SiO; CH₃(C₆H₅)SiO; (C₆H₅)₂SiO; CF₃CH₂CH₂(CH₃)SiO; NC—CH₂CH₂(CH₃)SiO.

It should be indicated furthermore that the hydroxylated polymers of formula (2) may optionally comprise, apart from the D units of formula R²₂SiO, T units of formula R²SiO_{3/2} and/or SiO₂ units in the proportion of at most 1% (these percentages expressing the number of T and/or Q units per 100 silicon atoms).

The crosslinking agents D intended to react with the C POSs of the polycondensation SM carry, hydroxyl crosslinking functional groups Fd and/or OR³ functional groups (R³═C₁-C₃₀ alkyl, C₂-C₃₀ alkenyl, aryl, which are optionally substituted (preferably halogenated)) precursor of the functional groups Fd, these crosslinking functional groups being capable of reacting with other functional groups Fc of the C POS and/or Fd of the crosslinking agent D. The latter, is preferably chosen from:
the silanes of general formula:
   R³₄₋ₐSi(OR)ₐ (3)
in which:
   the substituents R, which are identical or different, have the same general or specific meanings as those given above in formula (1) for R¹,
   the symbols R, which are identical or different, represent the same groups as those mentioned above in formula (1),
the products of partial hydrolysis of a silane of formula (3), the said crosslinking agent D being obligatory when the reactive C POS(s) are α,ω-dihydroxylated POSs, and optional (but desirable) when the reactive C POS(s) carry at each chain end condensable groups (other than OH) or hydrolysable groups.

As other examples of crosslinking agents D selected from monomeric silanes, there may be mentioned more particularly polyacyloxysilanes, polyalkoxysilanes, polyketiminoxysilanes and polyiminoxysilanes, and in particular the following silanes:

CH₃Si(OCOCH₃)₃; C₂H₅Si(OCOCH₃)₃; (CH₂═CH)Si(OCOCH₃)₃; C₆H₅Si(OCOCH₃)₃; CF₃CH₂CH₂Si(OCOCH₃)₃; NC—CH₂CH₂Si(OCOCH₃)₃; CH₂ClSi(OCOCH₂CH₃)₃; CH₃Si [ON═C(CH₃)C₂H₅]₂(OCH₂CH₂OCH₃); CH₃Si [ON═CH—(CH₃)₂]₂(OCH₂CH₂OCH₃); Si(OC₂H₅)₄; Si(O-n-C₃H₇)₄; Si(O-isoC₃H₇)₄; Si(OC₂H₄OCH₃)₄; CH₃Si(OCH₃)₃; CH₂═CHSi(OCH₃)₃; CH₃Si(OC₂H₄OCH₃)₃; ClCH₂Si(OC₂H₅)₃; CH₂═CHSi(OC₂H₄OCH₃)₃.

The products of partial hydrolysis, for example, of the polyalkoxysilanes, usually called polyalkyl silicates, are well known products. The product most commonly used is polyethyl silicate 40® obtained from the partial hydrolysis of Si(OC₂H₅)₄.

The crosslinking agents D preferably used in the case of the preferred use of α,ω-dihydroxylated POSs of formula (1) are the alkyltrialkoxysilanes and the tetraalkoxysilanes of formula (3) where R represents an alkyl radical having from 1 to 4 carbon atoms; and the products of partial hydrolysis of these preferred silanes.

Thirdly, the silicone material SM may be a polydehydrogenocondensation SM₃ which contains:
at least one C′ type POS carrying hydroxyl crosslinking functional groups Fc′ and/or OR′ functional groups (R′=C₁-C₃₀ alkyl, C₂-C₃₀ alkenyl, aryl, optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
and at least one B′ type POS carrying crosslinking functional groups Fb′ (SiH) capable of reacting with the OH or OR′ crosslinking functional groups Fb′ of the C′ POS(s).

For more details on C′ and B′, refernce will be made to the definitions given below for C and B respectively.

The role of the reinforcing filler/silicone oil suspension prepared in accordance with the invention is to be used in the production of liquid or pasty silicone compositions which can be crosslinked by polyaddition or polycondensation, preferably to a silicone elastomer in an ambient atmosphere at normal temperature or at a higher temperature, or of nonreactive (antifoam) liquid or pasty silicone compositions.

Accordingly, according to another of its aspects, the present invention relates to a method for producing a silicone composition which can be crosslinked by polyaddition, consisting in incorporating in particular into the suspension as prepared according to the method as defined above, the following products:
optionally one or more A POSs as defined above,
one or more B POSs as defined above,
optionally one or more nonreactive E POSs as defined above, which are useful as diluents,
a catalytic system comprising a catalyst, preferably of platinum nature, and optionally an inhibitor.

According to a first variant of this method:
the composition is produced in the form of two-component systems P₁ and P₂ intended to be brought into contact with each other in order to produce an elastomer crosslinked by polyaddition between the A and B POSs,
and the method is carried out such that only one of the parts P₁ or P₂ contains catalyst ε, the other containing the B POS.

According to a second variant of this method for preparing crosslinkable liquid compositions, a one-component system is prepared which is intended to crosslink in the ambient air and/or under the effect of temperature.

These compositions which can be crosslinked by polyaddition to elastomers may also comprise one or more functional additives η, such as for example a nonreinforcing filler consisting of chalk, quartz powder, diatomaceous earth, mica, kaolin, aluminas or iron oxides. These optional additives η may also consist of pigments, antiblocking agents, plasticizers or rheology modifiers, stabilizers or adhesion promoters.

The invention also relates to a method for, producing a silicone composition which can be crosslinked by polycondensation, characterized in that it consists in incorporating, in particular into the suspension as prepared according to the method as defined above, the following products:
β′—optionally one or more C POSs as defined above;
δ′—one or more crosslinking agents D;
γ′—optionally one or more E POSs, as defined above and useful as diluents;
ε——a catalytic system comprising a condensation catalyst;
ν′—optionally one or more semi-reinforcing, nonreinforcing or bulking fillers;
ρ′—optionally water;
κ′—optionally one or more additives chosen from pigments, plasticizers, other rheology modifiers, stabilizers and/or adhesion promoters.

As regards the fillers ν′, they generally have a particulate diameter greater than 0.1 μm and are preferably chosen from ground quartz, zirconates, calcined clays, diatomaceous earth, calcium carbonate, and aluminas.

According to a first variant of the method for producing a silicone composition which can be crosslinked or hardened by polycondensation to an elastomer, a one-component composition (that is to say having a single packaging) is produced which is intended to crosslink in the presence of moisture, in particular moisture provided by ambient air or by the water present and/or added to the composition, at room temperature and/or under the effect of temperature which may range for example from 25° C. to a value of less than 100° C. In this case, the crosslinking catalyst ε′ used is a metal catalyst which is chosen in particular from tin monocarboxylates, diorganotin dicarboxylates, a tin chelate of valency IV, a hexacoordinated tin chelate of valency IV, amino silanes, an, organic derivative of titanium, an organic derivative of zirconium.

According to a second variant of the method for preparing compositions which can be crosslinked to elastomers:
each composition is produced in the form of a two-component (or two-package) system P1 and P2, intended to be brought into contact with each other in order to give a polycondensation elastomer,
and the procedure is carried out such that only one of the parts P1 or P2 contains the catalyst ε′ and optionally the crosslinking agent(s) D, excluding the C POS.

In the case of the two-component compositions, the polycondensation catalyst ε′ used is preferably an organic derivative of tin as defined above, an amine or a mixture of these species or an organic derivative of titanium.

The invention also relates to a method for preparing a silicone composition which can be crosslinked by polydehydrogenocondensation, characterized in that a polydehydrogenocondensation SM₃ is used which contains:
at least one C′ type POS carrying hydroxyl crosslinking functional groups Fc′ and/or OR′ functional groups (R′=C₁-C₃₀ alkyl, C₂-C₃₀ alkenyl, aryl, optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
at least one reactive silicone oil B′ POS, whose crosslinking functional groups Fb′ are hydrogen functional groups, this B′ POS comprising at least two ≡Si—H groups per molecule (preferably at least three when the A POS comprises only two ≡Si-Vi groups per molecule), these ≡Si—H groups being advantageously present in the chain;
and/or at least one nonreactive E POS;
   and in that the following are incorporated:
a catalytic system comprising a polydehydrogenocondensation metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

The mixtures used in these methods may be produced using known and appropriate devices. They may be for example:

Conventional mixers customarily used for these preparations:
arm mixers,
internal mixers,
planetary mixers,
ploughshare mixers,
co- or counterrotating twin-shaft mixers,
continuous extruder-mixers,
or other batch or continuous devices:
   stirred reactors,
   static mixers.

The mixing operation is carried out at normal temperature and pressure and preferably under an inert atmosphere (N₂). It is in fact advisable that, under these conditions, the silicone oil, the water, but also the compatibilizing agent, are in liquid form in order to facilitate the mixing.

The examples which follow illustrate:
the preparation of the reinforcing filler suspensions in a silicone material, in accordance with the invention,
the application of these suspensions as raw material for the production of two-component compositions which can be crosslinked to polyaddition RTV II silicone elastomers,
and the evaluation of the viscoelastic properties of the suspensions and of the mechanical properties of the elastomers crosslinked by polyaddition which are obtained from the said suspensions.

### EXAMPLES

### Example 1

Preparation of a Suspension of Nonground Silica in a Silicone Oil M₂, with Hydrochloric Acid at the Start

885 g of Z160 type silica slurry (that is to say a nonground precipitated silica slurry with a specific surface area ≈160 m²/g; containing 23% dry extract by weight in water and consisting of an intermediate product from silica manufacture), 317 g of propan-2-ol (H bond stabilizer/initiator) and 217 g of 36% hydrochloric acid are loaded at room temperature into a 3 l reactor provided with an impeller-type stirrer and two counter-paddles. The reaction medium is placed under stirring and admixture of 272.5 g of trimethylchlorosilane (halosilane precursor of hydrophobic grafts for silica) and 133 g of hexamethyldisiloxane, (M₂: silicone material. SM constituting the silicone oil in which the treated silica is suspended) is poured in over 15 minutes. The reaction mixture is heated and left under reflux for 2 hours. The stirring is then stopped and the medium is left to separate by settling. The aqueous phase is drawn off and the silicone phase is washed three times with a total of 1 538 g of a sodium bicarbonate solution at 5% by weight. 580 g of silica suspension in an SM made of hexamethyldisiloxane with 7% aqueous phase are recovered.

IR analysis vCH/vSiO=1.75. This is proof that the silanols of the silica react with the chlorosilanes, which leads to hydrophobization of the silica in situ.

### Example 2

Preparation of a Suspension of Nonground Silica in a Silicone Oil M₂, without Hydrochloric Acid at the Start

885 g of Z160 type silica slurry and 317 g of propan-2-ol (H bond stabilizer/initiator) are loaded at room temperature into a 3 l reactor provided with an impeller-type stirrer and two counter-paddles. The reaction medium is placed under stirring and a mixture of 272.5 g of trimethylchlorosilane (halosilane precursor of hydrophobic grafts for silica) and 133 g of hexamethyldisiloxane (M₂: silicone material. SM constituting the silicone oil in which the treated silica is suspended) is poured in over 15 minutes. The reaction mixture is heated and left under reflux for 2 hours. The stirring is then stopped and the medium is left to separate by settling. The aqueous phase is drawn off and the silicone phase is washed three times with a total of 1 581 g of a sodium bicarbonate solution at 5% by weight. 580 g of silica suspension in an SM made of hexamethyldisiloxane with 7% aqueous phase are recovered.

IR analysis vCH/vSiO=1.65. This is proof that the silanols of the silica react with the chlorosilanes, which leads to hydrophobization of the silica in situ.

### Example 3

Preparation of a Suspension of Ground Silica in a Silicone Oil M₂, without Hydrochloric Acid at the Start

885 g of Z160 type silica slurry and 317 g of propan-2-ol (H bond stabilizer/initiator) are loaded at room temperature into a 3 l reactor provided with an impeller-type stirrer and two counter-paddles. The reaction medium is placed under stirring and a mixture of 272.5 g of trimethylchlorosilane (halosilane precursor of hydrophobic grafts for silica) and 133 g of hexamethyldisiloxane (M₂: silicone material. SM constituting the silicone oil in which the treated silica is suspended) is poured in over 15 minutes. The reaction mixture is heated and left under reflux for 2 hours. The stirring is then stopped and the medium is left to separate by settling. The aqueous phase is drawn off and the silicone phase is washed three times with a total of 1 591 g of a sodium bicarbonate solution at 5% by weight 571 g of silica suspension in an SM made of hexamethyldisiloxane with 5% aqueous phase are recovered.

IR analysis vCH/vSiO=1.70. This is proof that the silanols of the silica react with the chlorosilanes, which leads to hydrophobization of the silica in situ.

### Example 4

By using the same quantities of reagents but removing some in order to see their impact, the following results are obtained:

TABLE 1

| | Reagents removed in | IR analyses |
|---|---|---|
| Trials | relation to Example 1 | νCH/νSiO |
| Trial 4.1 | without hydrochloric acid | 1.65 |
| | [symbol] no problem | |
| Control trial 4.2 | without hydrochloric acid and | not determined |
| | without propan-2-ol | |
| | [symbol] silica ball without | |
| | decantation | |
| Control trial 4.3 | without propan-2-ol | not determined |
| | [symbol] nodecantation | |
| | and obtaining of gels | |
| Trial 4.4 | without hexamethyldisiloxane M₂ | 1.78 |
| | [symbol] no decantation and need | |
| | to add it for decantation | |

Conclusion:
[symbol] HCl not important at the beginning and it is generated during the reaction.
[symbol] Presence of propan-2-ol essential.
[symbol] Hexamethyldisiloxane not important for carrying out the reaction but necessary for the decantation and serves as Silicone Material SM in which the hydrophobic silica is suspended.

### Example 5

Preparation of a Suspension of Nonground Silica in a Silicone Oil M₂, with Hydrochloric Acid at the Start

885.40 g of Z160 type silica slurry and 217.29 g of 34% hydrochloric acid are loaded at room temperature into a 3 l reactor provided with an impeller-type stirrer and two counter-paddles. The reaction medium is placed under stirring and 125.26 g of sodium silicate 7N34 are added to the reaction medium over 30 seconds 317.91 g of propan-2-ol (H bond stabilizer/initiator) are then poured over the reaction medium over 2 minutes 30 seconds, followed by the addition, over 15 minutes, of a mixture of 272.5 g of trimethylchlorosilane (halosilane precursor of hydrophobic grafts for silica) and 124.52 g of hexamethyldisiloxane (M₂: silicone material. SM constituting the silicone oil in which the treated silica is suspended). The reaction mixture is heated and left under reflux for 3 hours. The stirring is then stopped and the reaction medium is left to separate by settling. The aqueous phase is drawn off and the MQ resin with a silica core is reextracted by adding 329.19 g of hexamethyldisiloxane and by washing twice with 806.18 g of water. After concentrating the volatiles by evaporation, 486.60 g of a suspension of MQ resin with a silica core in a silicone oil (SM) consisting of M₂ are obtained.

IR analysis vCH/vSiO=3.07. This is proof that the silanols of the silica react with the sodium silicate and the chlorosilanes, which leads to hydrophobization of the silica in situ.

1. A method for preparing a suspension of a silicic particulate filler, in a silicone material (SM) comprising:
SM₁polyaddition:
at least one type A polyorganosiloxane POS carrying alkenyl crosslinking functional groups Fa capable of reacting with the crosslinking functional groups Fb (SiH) of at least one B type POS, this A POS being taken alone or as a mixture with at least one nonreactive (E) POS;
and at least one B type POS carrying crosslinking functional groups Fb (SiH) capable of reacting with the alkenyl crosslinking functional groups Fa of the A POS(s);
and/or SM₂polycondensation:
at least one C type POS carrying hydroxyl crosslinking functional groups Fc and/or OR functional groups (R═C₁-C₃₀ alkyl, C₂-C₃₀ alkenyl, aryl, which are optionally substituted (preferably halogenated)) precursor of the functional groups Fc′, these crosslinking functional groups Fc being capable of reacting with crosslinking functional groups Fc of this C POS or of other C POSs, and with crosslinking functional groups of at least one crosslinking agent D, this C POS being taken alone or as a mixture with at least one nonreactive (E) POS;
and/or SM₃polydehydrogenocondensation:
at least one C′ type POS carrying hydroxyl crosslinking functional groups Fc′ and/or OR′ functional groups (R′=C₁-C₃₀ alkyl, C₂-C₃₀ alkenyl, aryl, which are optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS;
and at least one B′ type POS carrying crosslinking functional groups Fb′ (SiH) capable of reacting with the crosslinking functional groups Fb′ OH or OR′ of the C′ POS(s);
and/or SM₄:
or at least one nonreactive (E) POS;
this suspension being capable of being used in particular for producing compositions which can be crosslinked by polyaddition and/or by polycondensation and/or by dehydrogenocondensation or antifoam silicone compositions;
this method being of the type in which an aqueous suspension of silicic particulate filler is made hydrophobic by treating with at least one halogenated reagent, this treatment comprising a transfer of the silica made hydrophobic into a nonaqueous phase and at least one step for at least partial removal of water,
wherein:
a) an aqueous silica suspension is prepared or used which comprises:
silica,
water which is optionally acidified,
at least one hydrogen bond stabilizer/initiator,
b) optionally, part of the silicone material SM is incorporated into the aqueous silica suspension obtained at the end of step a);
c) hydrophobic units formed by ≡Si—(R^{c})_{1 to 3} with R^{c}=hydrogeno, C₁-C₃₀ alkyl, C₂-C₃₀ alkenyl, aryl, these groups R^{c} being optionally substituted (preferably halogenated), are grafted onto the silica by exposing this silica to halosilanes that are precursors of these units and by allowing the reaction to proceed, preferably while stirring the whole, optionally in the hot state;
d) the procedure is carried out such that the transfer of the silica grafted by hydrophobic units, from the aqueous phase to the nonaqueous phase, is carried out;
e) optionally, at least part of the aqueous phase and of the reaction by-products is drawn off;
f) the medium is cooled if necessary;
g) optionally, the residual acidity of the nonaqueous phase is washed off;
h) the totality or the remainder of the silicone material SM is mixed with the filler which is now hydrophobic;
i) the residual water is evaporated off;
j) and an oil is recovered which comprises a hydrophobic particulate filler suspension in a crosslinkable silicone material, preferably without ever passing via a dried hydrophobic silica.

2. The method according to claim 1, wherein the pH of this suspension is ≦2, preferably ≦1, at least during step a).

3. The method according to claim 1, wherein at least one precursor of silicone resin, preferably a silicate, and still more preferably a sodium silicate, is used in step a).

4. The method according to claim 1, wherein functional units other than hydrophobic units are grafted onto silica by exposing it to halosilane precursors of these functional grafts, the functions which can be given to the silica by these units being preferably those in the group consisting of the following functions: bactericidal, bacteriostatic, chromophoric, fluorescence, antifouling, and combinations thereof.

5. The method according to claim 1, wherein there are chosen one or more precipitated silicas whose BET specific surface area is between 50 and 400 m²/g and mixing conditions such that the dynamic viscosity at 25° C. of the suspension is less than or equal to 300 Pa·s, preferably less than or equal to 150 Pa·s.

6. The method according to claim 1, wherein the hydrogen bond stabilizer/initiator is chosen from organic solvents, preferably from the group consisting of alcohols, ketones, amides, alkanes and mixtures thereof.

7. The method according to any one of claim 1, wherein the acidification of the aqueous suspension (aqueous phase) is carried out using an acid, preferably an inorganic acid, and still more preferably an acid is chosen from the group consisting of HCl, H₂SO₄, H₃PO₄ and mixtures thereof.

8. The method according to claim 1, wherein the silicone material SM comprises at least one oligoorganosiloxane, preferably a diorganosiloxane, and still more preferably hexamethyldisiloxane (M₂).

9. The method according to claim 1, wherein the precursor of hydrophobic units is an alkylhalosilane, preferably an alkylchlorosilane, and still more preferably a methylchlorosilane.

10. The method according to claim 1, wherein a precipitated silica powder is used and wherein the following operations are carried out:
the relevant products are introduced into the stirred preparation vessel in the following order:
the aqueous silica suspension, optionally in several fractions, the hydrogen bond stabilizer/initiator—preferably consisting of isopropyl alcohol, optionally an acid—, preferably HCl—;
a precursor of hydrophobic units: —Si—(R^{c})_{1 to 3} with R^{c}=C₁-C₃₀ alkyl or a C₂-C₃₀ alkenyl—preferably (CH₃)₃SiCl—;
part of the SM comprising at least one oligoorganosiloxane—preferably hexamethyldisiloxane (M₂)—;
the medium is heated to a temperature in the region of the reflux temperature of the hydrogen bond stabilizer/initiator—preferably that of isopropyl alcohol between 70 and 80° C.;
the medium is optionally cooled;
the aqueous phase is separated from the nonaqueous phase—preferably by decantation—;
the nonaqueous phase is removed;
optionally at least once, this nonaqueous phase is washed with an aqueous liquid and then the aqueous washing phase is removed;
the optionally washed, nonaqueous silicone phase is mixed with all or the remainder of the silicone material SM, with the silica now hydrophobic, this SM preferably comprising at least one polyorganosiloxane POS;
an oily suspension of hydrophobic particulate silicic filler is recovered in a crosslinkable silicone material SM.

11. The method according to claim 10, wherein the various ingredients are used in the following proportions (parts by dry weight for all that is not water):
silica: 100;
acid (e.g. HCl): 20 to 60, preferably from 30 to 50;
precursor of —Si—(R^{c})_{1 to 3} {e.g. (CH₃)₃SiCl}, 5 to 500, preferably from 10 to 200;
H bond stabilizer/initiator (e.g. isopropanol): 0 to 20, preferably from 1 to 10;
SM oil: 40 to 2 000, consisting exclusively or otherwise of oligoorganosiloxane—preferably of M₂;
water: 2 to 8 000, preferably 200 to 1 000.

12. The method according to claim 1, wherein the silica used is mainly in the form of a slurry of precipitated silica(s).

13. The method according to claim 1, wherein a polyaddition SM is used which comprises:
at least one reactive silicone oil A POS whose crosslinking functional groups Fa are alkenyl—preferably vinyl—functional groups,
this A POS:
comprising at least two Si-Fa groups per molecule, preferably each situated at one end of the chain,
and having a dynamic viscosity at 25° C. of less than or equal to 250 Pa·s, preferably 100 Pa·s and still more preferably 10 Pa·s,
this A POS being intended to react with the B POS,
at least one reactive silicone oil B POS, whose crosslinking functional groups Fb are hydrogen functional groups, this B POS comprising at least two groups Si—H per molecule (preferably at least three when the A POS comprises only two Si-Vi groups per molecule), these Si—H groups being advantageously situated in the chain,
and/or at least one nonreactive E POS;
and wherein the following are incorporated:
a catalytic system comprising a polyaddition metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.

14. The method according to claim 1, wherein:
a polycondensation SM₂ is used which comprises:
at least one reactive silicone oil C POS whose crosslinking functional groups Fc react by polycondensation, these C POSs corresponding to the following formula (1): 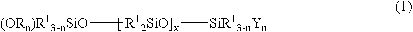
in which:
R¹ represents monovalent hydrocarbon radicals which are identical or different, and Y represents hydrolyzable or condensable groups OR¹¹ with R¹¹ corresponding to the same definition as that given above for R^{c},
n is chosen from 1, 2 and 3 with n=1, when R═H is a hydroxyl, and x has a sufficient value to confer on the oils of formula (1) a dynamic viscosity at 25° C. of between 1 000 and 200 000 mPa·s,
this C POS being intended to react with another C POS or with at least one crosslinking agent D,
and/or at least one nonreactive E POS different from the C POS(s);
and wherein the following are incorporated:
a catalytic system comprising a condensation metal catalyst;
optionally one or more semireinforcing, nonreinforcing or bulking fillers;
optionally water;
optionally one or more additives chosen from pigments, plasticizers, other rheology modifiers, stabilizers and/or adhesion promoters.

15. The method according to claim 1, wherein a polydehydrogeno-condensation SM₃ is used which comprises:
at least one C′ type POS carrying hydroxyl crosslinking functional groups Fc′ and/or OR′ functional groups (R′=C₁-C₃₀ alkyl, C₂-C₃₀ alkenyl, aryl, optionally substituted (preferably halogenated)) precursor of the functional groups Fc′, these crosslinking functional groups Fc′ being capable of reacting with other crosslinking functional groups Fb′ (SiH) of at least one B′ type POS, this C′ POS being taken alone or as a mixture with at least one nonreactive (E) POS,
at least one reactive silicone oil B′ POS, whose crosslinking functional groups Fb′ are hydrogen functional groups, this B′ POS comprising at least two ≡Si—H groups per molecule (preferably at least three when the A POS comprises only two ≡Si-Vi groups per molecule), these ≡Si—H groups being advantageously present in the chain,
and/or at least one nonreactive E POS;
and wherein the following are incorporated:
a catalytic system comprising a polydehydrogenocondensation metal catalyst (preferably of platinum nature) and optionally an inhibitor;
optionally one or more semireinforcing, nonreinforcing or bulking fillers;
optionally water;
optionally one or more additives chosen from pigments, plasticizers, other rheology modifiers, stabilizers and/or adhesion promoters.
